(19) United States
(12) Patent Application Publication
(10) Pub. No.: US 2026/0143095 A1
(43) Pub. Date: May 21, 2026

(54) OPTICAL MODULE AND PROJECTOR

(71) Applicant: SEIKO EPSON CORPORATION, Tokyo (JP)

(72) Inventor: Takuo YONEYAMA, AZUMINO-SHI (JP)

(21) Appl. No.: 19/394,140

(22) Filed: Nov. 19, 2025

(30) Foreign Application Priority Data
Nov. 20, 2024 (JP) 2024-202164

(51) Int. Cl. H04N 9/31

(52) U.S. Cl. CPC H04N 9/3135; H04N 9/3155; H04N 9/317

(57) ABSTRACT

An optical module includes: a light source configured to output light; a light scanner configured to periodically sweep the light output from the light source; and an image light generator configured to generate image light from swept light swept by the light scanner. The light scanner includes a diffractive optical element configured to diffract light at different angles of diffraction in accordance with a light incident position where the light from the light source is incident on the diffractive optical element, and a movement mechanism configured to move the diffractive optical element, and the swept light is scanned across the illuminated region of the image light generator as the diffractive optical element is moved.

The present application is based on, and claims priority from JP Application Serial Number 2024-202164, filed November 20, 2024, the disclosure of which is hereby incorporated by reference herein in its entirety.

### BACKGROUND

### 1. Technical Field

The present disclosure relates to an optical module and a projector.

### 2. Related Art

As a light source apparatus used for a projector, there has been a proposed light source apparatus that illuminates a light modulator, such as a liquid crystal panel, by temporally scanning the light modulator with the light emitted from a light emitter.

JP-A-2007-225956 discloses a projector including a light source apparatus including a light source lamp, a liquid crystal light valve, a polygonal mirror provided between the light source apparatus and the liquid crystal light valve, and a projection lens. In the projector, the light source apparatus outputs light having an elliptical luminous flux cross section. The polygonal mirror reflects the light output from the light source apparatus to scan an image formation region of the liquid crystal light valve in a minor axis direction of the elliptical luminous flux cross section.

JP-A-2007-225956 is an example of the related art.

Since the projector described above employs the configuration in which the polygonal mirror is used to sweep the illumination light, there is a problem of an increase in size of the projector configuration.

### SUMMARY

To solve the above problems, according to an aspect of the present disclosure, there is provided an optical module including: a light source configured to output light; a light scanner configured to periodically sweep the light output from the light source; and an image light generator configured to generate image light from swept light swept by the light scanner. The light scanner includes a diffractive optical element configured to diffract light at different angles of diffraction in accordance with a light incident position where the light from the light source is incident on the diffractive optical element, and a movement mechanism configured to move the diffractive optical element, and the swept light is scanned across the image light generator as the diffractive optical element is moved.

According to another aspect of the present disclosure, there is provided a projector including: the optical module described above; and a projection optical apparatus configured to project light output from the optical module.

### BRIEF DESCRIPTION OF THE DRAWINGS

FIG. 1 is a plan view showing a schematic configuration of a projector according to a first embodiment.

FIG. 2 is a cross-sectional view showing a schematic configuration of a first light scanner.

FIG. 3A shows the behavior of blue illumination light swept by the first light scanner.

FIG. 3B shows the behavior of the blue illumination light swept by the first light scanner.

FIG. 3C shows the behavior of the blue illumination light swept by the first light scanner.

FIG. 3D shows the behavior of the blue illumination light swept by the first light scanner.

FIG. 3E shows the behavior of the blue illumination light swept by the first light scanner.

FIG. 4 is a timing chart showing the temporal correspondence between a liquid crystal panel and the first light scanner.

FIG. 5A is a plan view of a first light scanner according to a variation viewed in a Z-axis direction.

FIG. 5B is a plan view of the first light scanner according to the variation viewed in an X-axis direction.

FIG. 6 is a cross-sectional view showing a schematic configuration of a blue light image module according to a second embodiment.

FIG. 7A shows the behavior of the blue illumination light output from the first light scanner.

FIG. 7B shows the behavior of the blue illumination light output from the first light scanner.

FIG. 7C shows the behavior of the blue illumination light output from the first light scanner.

FIG. 7D shows the behavior of the blue illumination light output from the first light scanner.

FIG. 7E shows the behavior of the blue illumination light output from the first light scanner.

### DESCRIPTION OF EMBODIMENTS

Embodiments of the present disclosure will be described below with reference to the drawings.

In the following drawings, elements may be drawn at different dimensional scales for clarity of the elements.

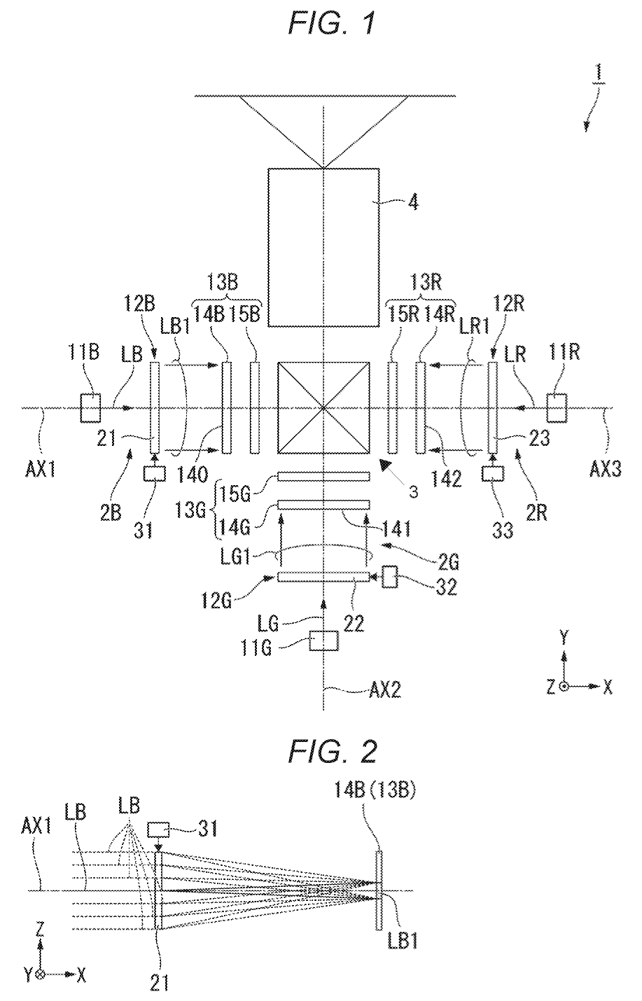

FIG. 1 is a plan view showing a schematic configuration of a projector according to one of the embodiments.

A projector 1 according to the present embodiment includes a blue light image module (optical module) 2B, a green light image module (optical module) 2G, a red light image module (optical module) 2R, an image combiner 3, and a projection optical apparatus 4, as shown in FIG. 1. In the present embodiment, the blue light image module 2B, the green light image module 2G, and the red light image module 2R each correspond to the "optical module" in the present disclosure.

The blue light image module 2B includes a first light source 11B, a first light scanner 12B, and a first image light generator 13B. The first light source 11B includes a laser light emitter that emits blue light LB having a blue wavelength band of, for example, 450 nm ±5 nm. The first light scanner 12B periodically sweeps the blue light LB output from the first light source 11B. Note that the configuration of the first light scanner 12B will be described later in detail. In the present embodiment, the first light source 11B, the first light scanner 12B, and the first image light generator 13B correspond to the "light source", the "light scanner", and the "image light generator" in the present disclosure, respectively.

The first image light generator 13B generates blue image light from the swept light swept by the first light scanner 12B. The first image light generator 13B includes a liquid crystal panel 14B and a light-exiting-side polarizer 15B. The liquid crystal panel 14B has an image formation region 140, which modulates the blue light LB swept by the first light scanner 12B in accordance with image information to form the blue image light. A twisted nematic (TN) method, a vertical alignment (VA) method, an in-plane switching (IPS) method, or any other method is used as a method for driving the liquid crystal panel 14B, but the driving method is not limited to a specific method.

The green light image module 2G includes a second light source 11G, a second light scanner 12G, and a second image light generator 13G. The second light source 11G includes a laser light emitter that emits green light LG having a green wavelength band of, for example, 530 nm ±5 nm. The second light scanner 12G periodically sweeps the green light LG output from the second light source 11G. Note that the configuration of the second light scanner 12G will be described later in detail. In the present embodiment, the second light source 11G, the second light scanner 12G, and the second image light generator 13G correspond to the "light source", the "light scanner", and the "image light generator" in the present disclosure, respectively.

The second image light generator 13G generates green image light from the swept light swept by the second light scanner 12G. The second image light generator 13G includes a liquid crystal panel 14G and a light-exiting-side polarizer 15G. The liquid crystal panel 14G has an image formation region 141, which modulates the green light LG swept by the second light scanner 12G in accordance with image information to form the green image light. The twisted nematic (TN) method, the vertical alignment (VA) method, the in-plane switching (IPS) method, or any other method is used as a method for driving the liquid crystal panel 14G, but the driving method is not limited to a specific method.

The red light image module 2R includes a third light source 11R, a third light scanner 12R, and a third image light generator 13R. The third light source 11R includes a laser light emitter that emits red light LR having a red wavelength band of, for example, 650 nm ±5 nm. The third light scanner 12R periodically sweeps the red light LR output from the third light source 11R. Note that the configuration of the third light scanner 12R will be described later in detail. In the present embodiment, the third light source 11R, the third light scanner 12R, and the third image light generator 13R correspond to the "light source", the "light scanner", and the "image light generator" in the present disclosure, respectively.

The third image light generator 13R generates red image light from the swept light swept by the third light scanner 12R. The third image light generator 13R includes a liquid crystal panel 14R and a light-exiting-side polarizer 15R. The liquid crystal panel 14R has an image formation region 142, which modulates the red light LR swept by the third light scanner 12R in accordance with image information to form the red image light. The twisted nematic (TN) method, the vertical alignment (VA) method, the in-plane switching (IPS) method, or any other method is used as a method for driving the liquid crystal panel 14R, but the driving method is not limited to a specific method.

The image combiner 3 outputs full-color image light that is the combination of the blue image light output from the first image light generator 13B, the green image light output from the second image light generator 13G, and the red image light output from the third image light generator 13R toward the projection optical apparatus 4. The image combiner 3 is, for example, a cross dichroic prism.

The projection optical apparatus 4 includes multiple projection lenses. The projection optical apparatus 4 enlarges the image light output from the image combiner 3, and projects the enlarged image light toward a projection receiving surface such as a screen. A full-color image is thus displayed on the projection receiving surface.

The configurations of the first light scanner 12B, the second light scanner 12G, and the third light scanner 12R will be subsequently described. The first light scanner 12B, the second light scanner 12G, and the third light scanner 12R have the same configuration except for the color of light to be swept. The configuration of the first light scanner 12B will be therefore described below by way of example, and the configurations of the second light scanner 12G and the third light scanner 12R will not be described or will be described in a simplified manner.

An XYZ orthogonal coordinate system will be used below as required in the drawings. The X-axis is an axis parallel to an optical axis AX1 of the blue light image module 2B. The optical axis AX1 is an axis along the chief ray of the blue light LB output from the first light source 11B. The Y-axis is an axis orthogonal to the X-axis and parallel to an optical axis AX2 of the green light image module 2G. The optical axis AX2 is an axis along the chief ray of the green light LG output from the second light source 11G. The Z-axis is an axis orthogonal to the X-axis and the Y-axis. An optical axis AX3 of the red light image module 2R coincides with the optical axis AX1 of the blue light image module 2B.

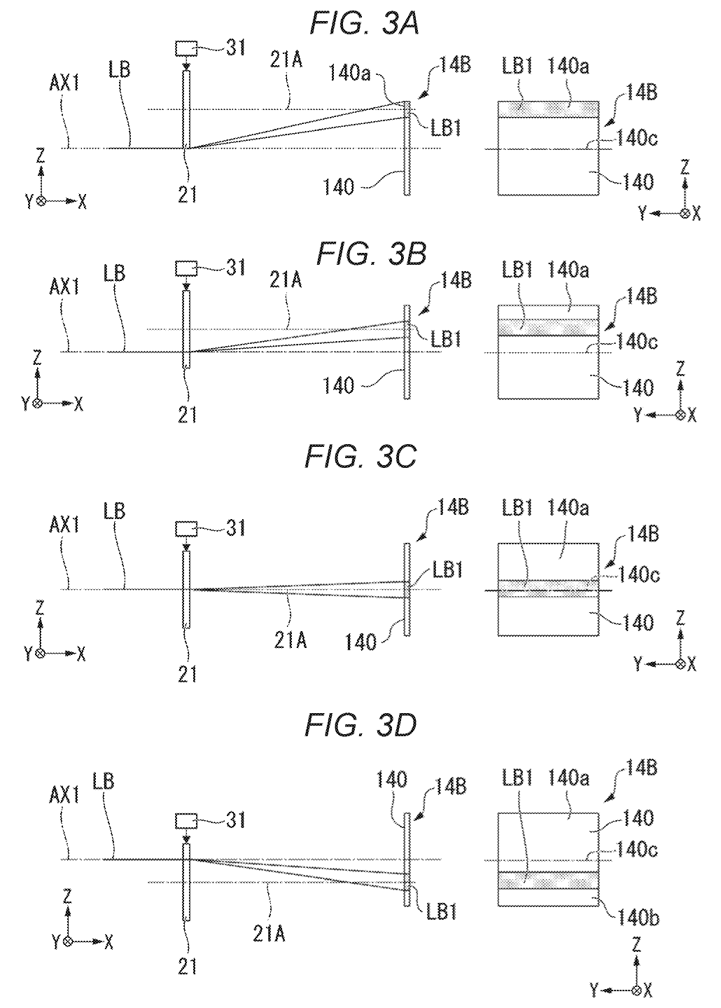

FIG. 2 is a cross-sectional view showing a schematic configuration of the first light scanner 12B. FIG. 2 is a cross-sectional view of the first light scanner 12B taken along the XZ plane. FIG. 2 shows the liquid crystal panel 14B, which is a target illuminated by the first light scanner 12B, and shows that a light incident position where the blue light LB is incident on a diffractive optical element 21 varies.

The first light scanner 12B includes the diffractive optical element 21 and a movement mechanism 31, as shown in FIG. 2. Specifically, the diffractive optical element 21 in the present embodiment is a computer generated hologram (CGH). The diffractive optical element 21 is made of a material that transmits the blue light LB. Examples of such a material may include quartz, optical glass, and transparent resin.

The angle of diffraction performed by the diffractive optical element 21 varies in accordance with the light incident position. Since the diffractive optical element 21 is configured with a computer generated hologram, the angle of diffraction of light can be controlled with high accuracy.

Accordingly, the diffractive optical element 21 allows the light having passed through the diffractive optical element 21 to converge on a center axis 21A of the diffractive optical element 21 by diffracting the light at an angle according to the light incident position.

More specifically, when the center axis 21A of the diffractive optical element 21 coincides with the optical axis AX1, the blue light LB having passed through the diffractive optical element 21 converges on the optical axis AX1 irrespective of the light incident position on the diffractive optical element 21, as shown in FIG. 2. Therefore, in the case shown in FIG. 2, the blue light LB having passed through the diffractive optical element 21 illuminates, as blue illumination light LB1, a central portion of the liquid crystal panel 14B located on the optical axis AX1 irrespective of the light incident position. Note that the position where the liquid crystal panel 14B is illuminated with the blue illumination light LB1 changes in accordance with the position of the diffractive optical element 21 with respect to the liquid crystal panel 14B, as will be described later.

The blue illumination light LB1, with which the liquid crystal panel 14B is illuminated, is strip-shaped light extending in the Y-axis direction. Specifically, the cross-sectional shape of the blue illumination light LB1 that is the shape perpendicular to the chief ray thereof is a rectangular shape having lengthwise sides along the Y-axis direction and widthwise sides along the Z-axis direction. The lengthwise size of the blue illumination light LB1 is equal to or greater than a width of the rectangular image formation region 140 of the liquid crystal panel 14B that is the width in the Y-axis direction. The widthwise size of the blue illumination light LB1 is smaller than a width of the rectangular image formation region 140 of the liquid crystal panel 14B that is the width in the Z-axis direction.

The movement mechanism 31 is a driving apparatus that moves the diffractive optical element 21, and is configured, for example, with an actuator. The blue illumination light LB1 scans the first image light generator 13B as the diffractive optical element 21 is moved by the movement mechanism 31. In the present embodiment, the blue illumination light LB1 corresponds to an example of the "swept light" in the present disclosure.

The movement mechanism 31 can move the diffractive optical element 21 back and forth in the Z-axis direction. That is, the movement mechanism 31 can move the diffractive optical element 21 toward the −Z side and the +Z side with respect to the liquid crystal panel 14B.

In the present embodiment, the direction in which the diffractive optical element 21 is moved by the movement mechanism 31 is the Z-axis direction along the widthwise direction of the blue illumination light LB1. The blue illumination light LB1 scans the liquid crystal panel 14B in the Z-axis direction along the widthwise direction. According to the configuration described above, in which the elongated blue illumination light LB1 is swept in the widthwise direction, the image formation region 140 can be efficiently illuminated with an increase in the widthwise dimension of the blue illumination light LB1 suppressed, as compared with a case where the blue illumination light LB1 is swept in the lengthwise direction.

The Z-axis direction in the present embodiment corresponds to the "axial direction" in the present disclosure, the −Z side in the Z-axis direction corresponds to the "one side in the axial direction" in the present disclosure, and the +Z side in the Z-axis direction corresponds to the "another side in the axial direction" in the present disclosure.

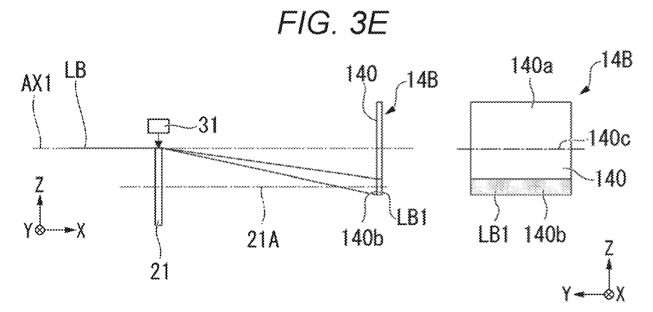

FIGS. 3A to 3E show the behavior of the blue illumination light LB1 output from the first light scanner 12B. FIGS. 3A to 3E show a case where the diffractive optical element 21 is moved from the +Z side toward the −Z side across the optical axis AX1. In FIGS. 3A to 3E, the left side shows the amount of displacement of the blue illumination light LB1 from the optical axis AX1, and the right side shows a state in which the blue illumination light LB1 scans the image formation region 140 of the liquid crystal panel 14B, which is an illumination receiving region. In the description using FIGS. 3A to 3E, the +Z side may be referred to as an upper side, and the −Z side may be referred to as a lower side.

In the state shown in FIG. 3A, the diffractive optical element 21 is so disposed that the −Z-side lower end portion thereof is located on the optical axis AX1. Therefore, in the Z-axis direction, the lower end of the diffractive optical element 21 is located at the center of the liquid crystal panel 14B, and the center axis 21A of the diffractive optical element 21 is located in an +Z-side upper end portion 140a of the image formation region 140 of the liquid crystal panel 14B.

As described above, the blue light LB having passed through the diffractive optical element 21 is incident on the liquid crystal panel 14B as the blue illumination light LB1 caused to converge on the center axis 21A of the diffractive optical element 21. Therefore, in the state shown in FIG. 3A, the blue illumination light LB1 illuminates the upper end portion 140a of the image formation region 140.

Subsequently, when the diffractive optical element 21 is moved toward the lower side (−Z side) by the movement mechanism 31, the center axis 21A of the diffractive optical element 21 is also moved toward the lower side (−Z side), so that the distance between the center axis 21A and the optical axis AX1 decreases, as shown in FIG. 3B. Accordingly, the center axis 21A of the diffractive optical element 21 moves toward the side (−Z side) below the upper end portion 140a of the image formation region 140 of the liquid crystal panel 14B, so that the blue illumination light LB1 illuminates the side (−Z side) below the upper end portion 140a of the image formation region 140.

Subsequently, when the diffractive optical element 21 is further moved toward the lower side (−Z side) by the movement mechanism 31, the center axis 21A of the diffractive optical element 21 coincides with the optical axis AX1, as shown in FIG. 3C. At this point in time, the center axis 21A of the diffractive optical element 21 coincides with the center 140c of the image formation region 140 of the liquid crystal panel 14B, and the blue illumination light LB1 illuminates the center 140c of the image formation region 140.

Subsequently, when the diffractive optical element 21 is further moved toward the lower side (−Z side) by the movement mechanism 31, the center axis 21A of the diffractive optical element 21 moves away from the optical axis AX1 toward the lower side (−Z side), so that the distance between the center axis 21A and the optical axis AX1 increases, as shown in FIG. 3D. Accordingly, the center axis 21A of the diffractive optical element 21 moves toward the side (−Z side) below the center 140c of the image formation region 140 of the liquid crystal panel 14B, so that the blue illumination light LB1 illuminates the side (−Z side) below the center 140c of the image formation region 140.

Subsequently, when the diffractive optical element 21 is further moved toward the lower side (−Z side) by the movement mechanism 31, the center axis 21A of the diffractive optical element 21 is located in a −Z-side lower end portion 140b of the image formation region 140 of the liquid crystal panel 14B, as shown in FIG. 3E. Therefore, in the state shown in FIG. 3E, the blue illumination light LB1 illuminates the lower end portion 140b of the image formation region 140.

As described above, the movement mechanism 31 moves the diffractive optical element 21 from the upper side toward the lower side, so that the first light scanner 12B can scan the image formation region 140 of the liquid crystal panel 14B with the blue illumination light LB1 from the upper side toward the lower side. The first light scanner 12B can therefore illuminate the entire rectangular image formation region 140 with the blue illumination light LB1.

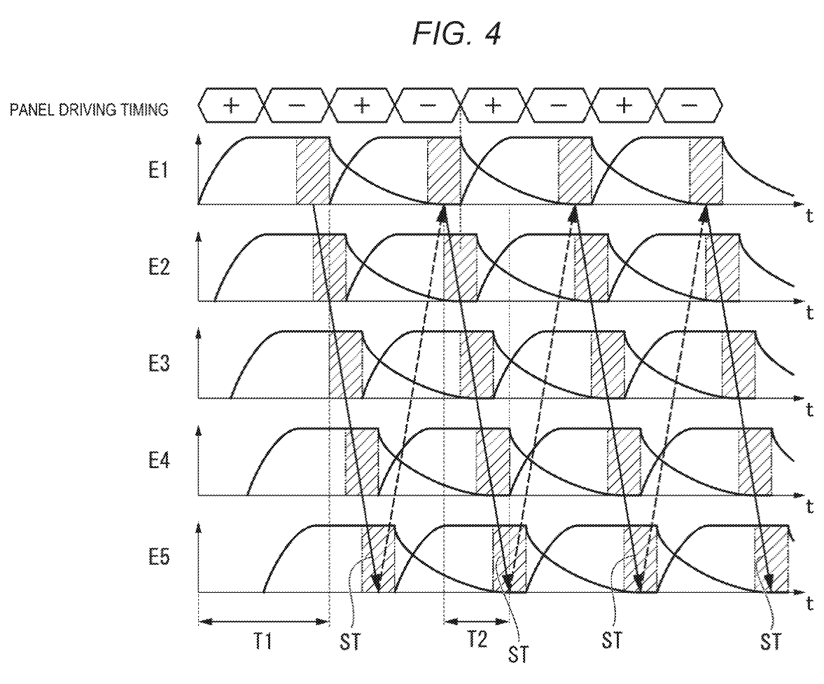

A temporal correspondence between the timing at which the liquid crystal panel 14B is driven and the timing at which the blue illumination light LB1 is swept by the first light scanner 12B will be subsequently described. FIG. 4 is a timing chart showing the temporal correspondence between the liquid crystal panel 14B and the first light scanner 12B.

In FIG. 4, E1 to E5 indicate the correspondence of rotation efficiency at each position in the upward-downward direction (Z-axis direction) of the image formation region 140 of the liquid crystal panel 14B. The rotation efficiency of the liquid crystal panel 14B means the proportion of the linearly polarized light that enters the liquid crystal layer and is converted into linearly polarized light rotated by 90 degrees with respect to the incident linearly polarized light.

Specifically, the position E1 corresponds to the upper end portion 140a of the image formation region 140, the position E5 corresponds to the lower end portion 140b of the image formation region 140, the position E3 corresponds to the center 140c of the image formation region 140, the position E2 corresponds to the portion between the upper end portion 140a and the center 140c of the image formation region 140, and the position E4 corresponds to the portion between the center 140c and the lower end portion 140b of the image formation region 140.

In FIG. 4, ST indicates a scan period for which the blue illumination light LB1 scans the image formation region 140. That is, in each of the scan periods ST, the first light source 11B outputs the blue light LB.

The liquid crystal panel 14B generates image light in the image formation region 140 by causing a scan line driving circuit that is not shown to sequentially select multiple scan lines one at a time, as shown in FIG. 4. A state in which the multiple scan lines are sequentially selected by the scan line driving circuit as described above is referred to as "vertical scanning", and a direction in which the scan lines are sequentially swept by the vertical scanning performed by the scan line driving circuit is referred to as "vertical scanning direction".

In the liquid crystal panel 14B in the present embodiment, the Z-axis direction, in which the positions E1 to E5 in the image formation region 140 are arranged, corresponds to the vertical scanning. In the present embodiment, the vertical scanning direction of the liquid crystal panel 14B is the same as the direction in which the blue illumination light LB1 scans the image formation region 140 as the diffractive optical element 21 is moved toward the lower side (−Z side).

According to the configuration described above, causing the direction in which the blue illumination light LB1 is swept to coincide with the vertical scanning direction of the liquid crystal panel 14B allows the operation of sweeping the blue illumination light LB1 to start at a timing before the vertical scanning of the image formation region 140 is completed. Therefore, a situation in which the diffractive optical element 21 is accelerated by the movement mechanism 31 can be suppressed as compared with a case where the operation of sweeping the blue illumination light LB1 starts after the vertical scanning is completed, so that a risk of damage or failure of the movement mechanism 31 can be reduced by reducing the load thereon, and the power consumed by the movement mechanism 31 can be suppressed.

Since the vertical scanning direction of the image formation region 140 is the direction from the +Z side toward the −Z side, the timings at which the rotation efficiency at the positions E1 to E5 reaches 100% deviate from each other. That is, the rotation efficiency reaches 100% at the earliest timing at the position E1 located most upstream in the vertical scanning direction, and reaches 100% at the latest timing at the position E5 located most downstream in the vertical scanning direction.

In the present embodiment, the scan period ST, for which the image formation region 140 is scanned with the blue illumination light LB1, starts at the timing when the rotation efficiency at each of the positions E1 to E5 in the image formation region 140 becomes 100%. The image formation region 140 can thus generate image light having desired brightness by efficiently modulating the blue illumination light LB1.

In FIG. 4, T1 indicates a cycle of the vertical scanning of the liquid crystal panel 14B, and T2 indicates the cycle of the operation of sweeping the blue illumination light LB1 performed by the first light scanner 12B. In the present embodiment, for example, T1 is 1/240 seconds, T2 is 1/480 seconds, and the cycle T1 of the vertical scanning is twice the scan cycle T2.

In the present embodiment, the image formation region 140 is scanned with the blue illumination light LB1 by moving the diffractive optical element 21 from the upper side toward the lower side in one frame produced by the liquid crystal panel 14B, as described above. Therefore, after the blue illumination light LB1 scans the image formation region 140 once from the upper side toward the lower side, the diffractive optical element 21 needs to return to the upper side again. The first light scanner 12B therefore needs to move the diffractive optical element 21 back and forth in one frame produced by the liquid crystal panel 14B.

Consider now the state of the first light source 11B in the case where the diffractive optical element 21 is caused to return to the upper side. For example, when the diffractive optical element 21 is moved upward with the first light source 11B kept turned on, the image formation region 140 is scanned with the blue illumination light LB1 in the reverse direction from the position E5 toward the position E1 at the timings indicated by the dashed arrows in FIG. 4. However, since the state at the position E5 is a state before the displayed content is switched to that in the next frame at the timing when the blue illumination light LB1 passes through the position E5 in the image formation region 140, so that the rotation efficiency at the position E4 has not reached 100% at the timing when the blue illumination light LB1 passes through the position E4 in the image formation region 140, there is a concern that the blue illumination light LB1 cannot be satisfactorily modulated and the image quality deteriorates due to the modulation failure.

In contrast, in the blue light image module 2B in the present embodiment, the first light source 11B is kept turned on while the diffractive optical element 21 is being moved toward the lower side (−Z side) in the first light scanner 12B, and the first light source 11B is kept turned off while the diffractive optical element 21 is being moved toward the upper side (+Z side). The thus configured present embodiment can suppress the deterioration of the image quality due to the situation in which the liquid crystal panel 14B in a state in which the rotation efficiency is insufficient fails to modulate the blue illumination light LB1, with the power consumed by the first light source 11B suppressed.

As described above, the blue light image module 2B in the present embodiment includes the first light source 11B, which outputs the blue light LB, the first light scanner 12B, which periodically sweeps the blue light LB output from the first light source 11B, and the first image light generator 13B, which generates image light from the blue illumination light LB1 swept by the first light scanner 12B. The first light scanner 12B includes the diffractive optical element 21, which diffracts light at various angles of diffraction in accordance with the light incident position, and the movement mechanism 31, which moves the diffractive optical element 21. The blue illumination light LB1 scans the liquid crystal panel 14B of the first image light generator 13B as the diffractive optical element 21 is moved.

According to the blue light image module 2B in the present embodiment, moving the diffractive optical element 21 on which the blue light LB output from the first light source 11B is incident allows the blue illumination light LB1 to scan the liquid crystal panel 14B with the size of the projector configuration reduced, as compared with the configuration in which a polygonal mirror is used to sweep illumination light as in the related art. The liquid crystal panel 14B can therefore generate bright, high-quality image light.

The above description has been made with reference to the configuration of the first light scanner 12B of the blue light image module 2B, and the second light scanner 12G of the green light image module 2G and the third light scanner 12R of the red light image module 2R are also configured in the same manner as the first light scanner 12B.

The second light scanner 12G includes a diffractive optical element 22 and a movement mechanism 32. The green light image module 2G in the present embodiment, in which the movement mechanism 32 of the second light scanner 12G moves the diffractive optical element 22, allows green illumination light LG1 to scan the image formation region 141 of the liquid crystal panel 14G, with an increase in the size of the projector configuration suppressed. The liquid crystal panel 14G can therefore generate bright, high-quality image light.

In the green light image module 2G in the present embodiment, the second light source 11G is kept turned on while the diffractive optical element 22 is being moved toward the lower side (−Z side) in the second light scanner 12G, and the second light source 11G is kept turned off while the diffractive optical element 22 is being moved toward the upper side (+Z side). The configuration described above can suppress the deterioration of the image quality due to the situation in which the liquid crystal panel 14G fails to modulate the green illumination light LG1, with the power consumed by the second light source 11G suppressed.

The third light scanner 12R includes a diffractive optical element 23 and a movement mechanism 33. The red light image module 2R in the present embodiment, in which the movement mechanism 33 of the third light scanner 12R moves the diffractive optical element 23, allows red illumination light LR1 to scan the image formation region 142 of the liquid crystal panel 14R, with an increase in the size of the projector configuration suppressed. The liquid crystal panel 14R can therefore generate bright, high-quality image light.

In the red light image module 2R in the present embodiment, the third light source 11R is kept turned on while the diffractive optical element 23 is being moved toward the lower side (−Z side) in the third light scanner 12R, and the third light source 11R is kept turned off while the diffractive optical element 23 is being moved toward the upper side (+Z side). The configuration described above can suppress the deterioration of the image quality due to the situation in which the liquid crystal panel 14R fails to modulate the red illumination light LR1, with the power consumed by the third light source 11R suppressed.

The projector 1 according to the present embodiment includes the blue light image module 2B, the green light image module 2G, the red light image module 2R, and the projection optical apparatus 4, which projects the blue image light output from the blue light image module 2B, the green image light output from the green light image module 2G, and the red image light output from the red light image module 2R.

The projector 1 according to the present embodiment can be a projector that projects a high-quality image while suppressing an increase in the size of the projector configuration.

### Variation

A variation of the projector according to the embodiment described above will be subsequently described. The present variation differs from the embodiment described above in the configuration of the light scanner of each of the image modules. The first light scanner will be described below by way of example, and the same applies to the second and third light scanners.

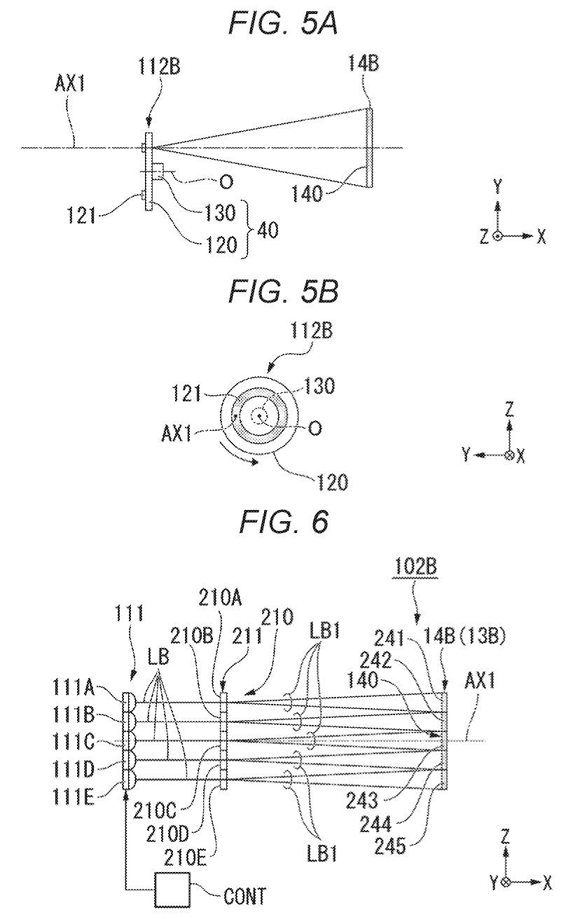

FIG. 5A is a plan view showing a schematic configuration of a first light scanner 112B according to the present variation. FIG. 5A shows the first light scanner 112B viewed from the +Z side. FIG. 5B is a plan view of the first light scanner 112B according to the present variation viewed in the X-axis direction along the optical axis AX1.

The first light scanner 112B includes a diffractive optical element 121 and a movement mechanism 40, as shown in FIG. 5A. The movement mechanism 40 in the present variation includes a disk 120 and a rotation driver 130. The disk 120 is a light transmissive substrate that supports the diffractive optical element 121. The diffractive optical element 121 is disposed along the circumferential direction of the disk 120. That is, the diffractive optical element 121 is provided in an annular shape around an axis of rotation O. The rotation driver 130 is configured, for example, with a motor, and rotates the disk 120 around the axis of rotation O.

The first light scanner 112B is so disposed that a portion of the diffractive optical element 121 overlaps with the optical axis AX1, as shown in FIG. 5B. In the first light scanner 112B according to the present variation example, the diffractive optical element 121 is moved with respect to the blue light LB by rotating the disk 120. The position where the blue light LB is incident on the diffractive optical element 121 thus changes.

According to the present variation, since the diffractive optical element 121 is moved toward the +Z side with respect to the optical axis AX1 by the rotation of the disk 120 as shown in FIG. 5B, the image formation region 140 of the liquid crystal panel 14B can be scanned with the blue illumination light LB1 having passed through the diffractive optical element 121 toward the −Y side, as in the embodiment described above.

In the present variation, the diffractive optical element 121 may be formed in an annular shape in the circumferential direction of the disk 120, or may have a structure in which the diffractive optical element 121 is divided into multiple elements in the circumferential direction of the disk 120.

In the present variation, the first light source 11B may be turned off so that the blue light LB is not incident on the diffractive optical element 121 at any timing when the rotation efficiency of the liquid crystal panel 14B has not reached 100%, or the blue light LB may be blocked by a light blocking member provided on the light incident side of the diffractive optical element 121.

In the present variation, the blue illumination light LB1 may scan the image formation region 140 once or multiple times while the disk 120 makes one revolution.

Second embodiment

A projector according to a second embodiment will be subsequently described. The present embodiment differs from the embodiment described above in the configuration of each of the image modules. The blue light image module will be described below by way of example, and the same applies to the green light image module and the red light image module. Members and configurations common to those in the embodiment described above have the same reference characters, and will not be described in detail or will be described in a simplified manner.

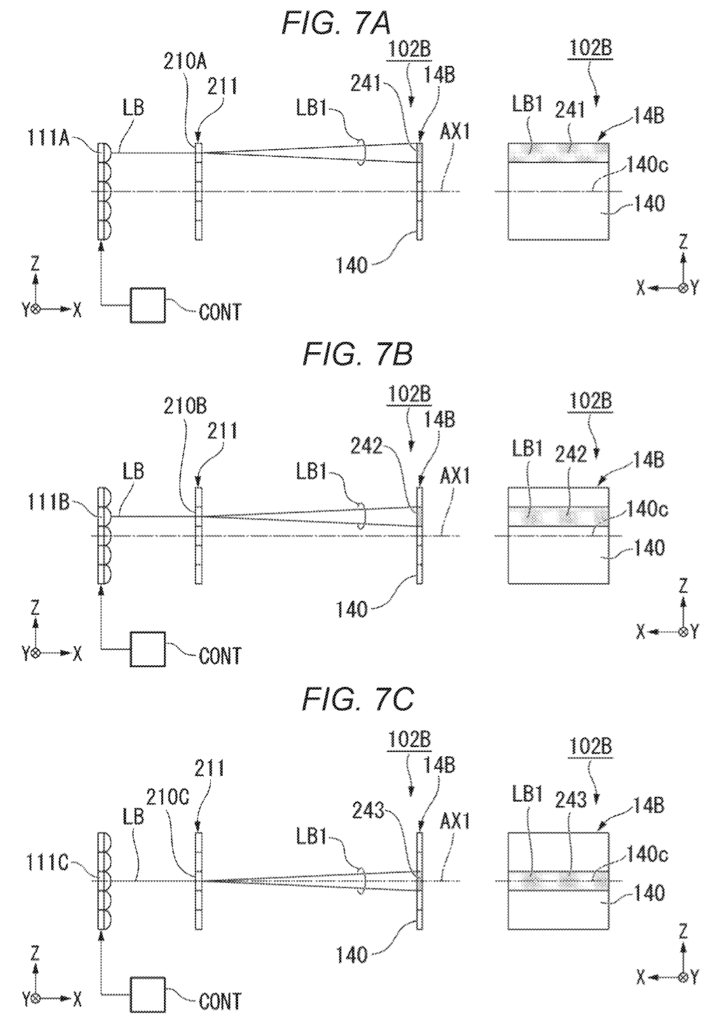

FIG. 6 is a cross-sectional view showing a schematic configuration of a blue light image module 102B according to the present embodiment.

The blue light image module 102B includes a first light source 111, a first light scanner 210, and the first image light generator 13B, as shown in FIG. 6. In the present embodiment, the first light source 111 and the first light scanner 210 correspond to the "light source" and the "light scanner" in the present disclosure, respectively.

The first light source 111 in the present embodiment includes a first light emitter 111A, a second light emitter 111B, a third light emitter 111C, a fourth light emitter 111D, and a fifth light emitter 111E. The light emitters 111A to 111E are arranged in this order in the direction from the +Z side toward the −Z side, which is the direction in which the blue illumination light LB1 is swept.

The first light scanner 210 includes a diffractive element unit 211 and a controller CONT. In the diffractive element unit 211, a first diffractive optical element 210A, a second diffractive optical element 210B, a third diffractive optical element 210C, a fourth diffractive optical element 210D, and a fifth diffractive optical element 210E are arranged in this order in the direction in which the blue illumination light LB1 is swept. Note that the diffractive optical elements 210A to 210E of the diffractive element unit 211 may be arranged with a gap therebetween in the Z-axis direction, or may be arranged in contact with each other. Each of the diffractive optical elements 210A to 210E of the diffractive element unit 211 is a computer generated hologram (CGH), and diffracts the light incident from the corresponding light emitter.

In the present embodiment, the image formation region 140 of the liquid crystal panel 14B has a first illuminated region 241, a second illuminated region 242, a third illuminated region 243, a fourth illuminated region 244, and a fifth illuminated region 245 arranged in the direction in which the blue illumination light LB1 is swept.

The first diffractive optical element 210A diffracts the blue light LB incident from the first light emitter 111A to illuminate the first illuminated region 241 of the liquid crystal panel 14B. Note that the center axis of the first diffractive optical element 210A coincides with the center axis of the first illuminated region 241.

The second diffractive optical element 210B diffracts the blue light LB incident from the second light emitter 111B to illuminate the second illuminated region 242 of the liquid crystal panel 14B. Note that the center axis of the second diffractive optical element 210B coincides with the center axis of the second illuminated region 242.

The third diffractive optical element 210C diffracts the blue light LB incident from the third light emitter 111C to illuminate the third illuminated region 243 of the liquid crystal panel 14B. Note that the center axis of the third diffractive optical element 210C coincides with the center axis of the third illuminated region 243.

The fourth diffractive optical element 210D diffracts the blue light LB incident from the fourth light emitter 111D to illuminate the fourth illuminated region 244 of the liquid crystal panel 14B. Note that the center axis of the fourth diffractive optical element 210D coincides with the center axis of the fourth illuminated region 244.

The fifth diffractive optical element 210E diffracts the blue light LB incident from the fifth light emitter 111E to illuminate the fifth illuminated region 245 of the liquid crystal panel 14B. Note that the center axis of the fifth diffractive optical element 210E coincides with the center axis of the fifth illuminated region 245.

The controller CONT is configured with a computer or an integrated circuit having, as a program, a built-in process of controlling the operation of driving each of the light emitters 111A to 111E. That is, the controller CONT is, for example, a processor. The controller CONT is coupled to each of the light emitters 111A to 111E wirelessly or via wires that are not shown. Note that the controller CONT may control the operation of driving other elements of the projector 1 in addition to the first light source 111.

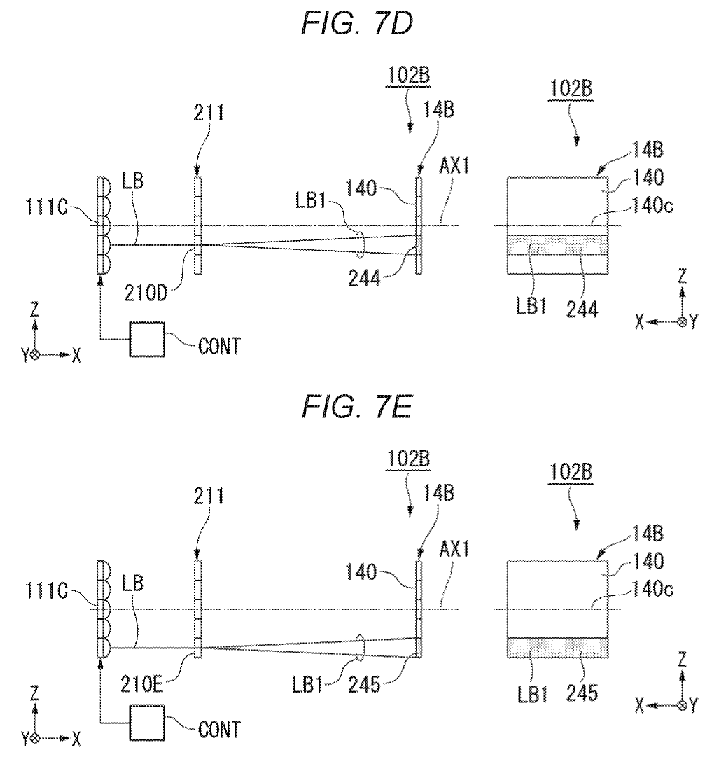

FIGS. 7A to 7E show the behavior of the blue illumination light LB1 output from the first light scanner 210 and incident on the liquid crystal panel 14B. FIGS. 7A to 7E sequentially show the process of switching the light emission state of the light emitters 111A to 111E of the first light source 111 sequentially from the +Z side toward the −Z side. In FIGS. 7A to 7E, the left side shows the behavior of the blue illumination light LB1 viewed from the −Y side, and the right side shows the state in which the blue illumination light LB1 scans the image formation region 140 of the liquid crystal panel 14B, which is the illumination receiving region. In the description using FIGS. 7A to 7E, the +Z side may be referred to as an upper side, and the −Z side may be referred to as a lower side.

The controller CONT turns on only the first light emitter 111A of the first light source 111, as shown in FIG. 7A. The blue light LB emitted from the first light emitter 111A enters the first diffractive optical element 210A, and illuminates, as the blue illumination light LB1, the first illuminated region 241 located at the uppermost end portion of the image formation region 140.

The controller CONT subsequently turns off the first light emitter 111A and turns on only the second light emitter 111B, as shown in FIG. 7B. The blue light LB emitted from the second light emitter 111B enters the second diffractive optical element 210B, and illuminates, as the blue illumination light LB1, the second illuminated region 242 located below the first illuminated region 241.

The controller CONT subsequently turns off the second light emitter 111B and turns on only the third light emitter 111C, as shown in FIG. 7C. The blue light LB emitted from the third light emitter 111C enters the third diffractive optical element 210C, and illuminates, as the blue illumination light LB1, the third illuminated region 243 located below the second illuminated region 242.

The controller CONT subsequently turns off the third light emitter 111C and turns on only the fourth light emitter 111D, as shown in FIG. 7D. The blue light LB emitted from the fourth light emitter 111D enters the fourth diffractive optical element 210D, and illuminates, as the blue illumination light LB1, the fourth illuminated region 244 located below the third illuminated region 243.

The controller CONT subsequently turns off the fourth light emitter 111D and turns on only the fifth light emitter 111E, as shown in FIG. 7E. The blue light LB emitted from the fifth light emitter 111E enters the fifth diffractive optical element 210E, and illuminates, as the blue illumination light LB1, the fifth illuminated region 245 located below the fourth illuminated region 244 and at the lowermost end portion of the image formation region 140.

As described above, the blue light image module 102B in the present embodiment includes the first light source 111, which outputs the blue light LB, the first light scanner 210, which periodically sweeps the blue light LB output from the first light source 111, and the first image light generator 13B, which generates image light from the blue illumination light LB1 swept by the first light scanner 210.

The first light source 111 includes the first light emitter 111A, the second light emitter 111B, the third light emitter 111C, the fourth light emitter 111D, and the fifth light emitter 111E arranged side by side in the direction in which the blue light LB is swept.

The first light scanner 210 includes the first diffractive optical element 210A, which diffracts the light incident from the first light emitter 111A to illuminate the first illuminated region 241 of the first image light generator 13B, the second diffractive optical element 210B, which is disposed at a position shifted from the first diffractive optical element 210A in the sweeping direction and diffracts the light incident from the second light emitter 111B to illuminate the second illuminated region 242 of the first image light generator 13B, the third diffractive optical element 210C, which is disposed at a position shifted from the second diffractive optical element 210B in the sweeping direction and diffracts the light incident from the third light emitter 111C to illuminate the third illuminated region 243 of the first image light generator 13B, the fourth diffractive optical element 210D, which is disposed at a position shifted from the third diffractive optical element 210C in the sweeping direction and diffracts the light incident from the fourth light emitter 111D to illuminate the fourth illuminated region 244 of the first image light generator 13B, the fifth diffractive optical element 210E, which is disposed at a position shifted from the fourth diffractive optical element 210D in the sweeping direction and diffracts the light incident from the fifth light emitter 111E to illuminate the fifth illuminated region 245 of the first image light generator 13B, and the controller CONT, which controls the operation of driving each of the light emitters 111A to 111E.

The controller CONT sequentially turns on the light emitters 111A to 111E, so that the blue light LB sequentially illuminates the illuminated regions 241 to 245.

According to the blue light image module 2B in the present embodiment, the blue light LB can be sequentially incident on the diffractive optical elements 210A to 210E by switching the operation of turning on the light emitters 111A to 111E of the first light source 111 from one to another. Accordingly, the blue illumination light LB1 output from the diffractive optical elements 210A to 210E can scan the illuminated regions 241 to 245 of the image formation region 140 of the liquid crystal panel 14B from the upper side toward the lower side. The configuration described above allows the blue illumination light LB1 to scan the liquid crystal panel 14B while reducing the size of the projector configuration as compared with the configuration in which a polygonal mirror is used to sweep illumination light as in the related art. The liquid crystal panel 14B can therefore generate bright, high-quality image light.

Note that the present embodiment has been described with reference to the case where the number of the light emitters of the first light source 111, the number of the diffractive optical elements arranged in correspondence with the light emitters, and the number of the illuminated regions of the image formation region 140 are five, but not necessarily. In the present disclosure, the number of the light emitters of the first light source 111 and the number of the diffractive optical elements disposed in correspondence with the light emitters only needs to be set to at least three or more.

The above description has been made with reference to the configuration of the first light scanner 210 of the blue light image module 102B, and the second light scanner of the green light image module and the third light scanner of the red light image module also have the same configuration as the first light scanner 210.

Therefore, according to the green light image module in the present embodiment, the image formation region of the liquid crystal panel 14G can be scanned with the green illumination light by switching the operation of turning on the light emitters of the second light source from one to another with an increase in the size of the projector configuration suppressed. The liquid crystal panel 14G can therefore generate bright, high-quality image light.

Furthermore, according to the red light image module in the present embodiment, the image formation region of the liquid crystal panel 14R can be scanned with the red illumination light by switching the operation of turning on the light emitters of the third light source from one to another with an increase in the size of the projector configuration suppressed. The liquid crystal panel 14R can therefore generate bright, high-quality image light.

The projector according to the present embodiment, which includes the blue light image module 102B described above and the green light image module and the red light image module configured in the same manner as the blue light image module 102B, can be a projector that projects a high-quality image with an increase in the size of the projector configuration suppressed.

The technical scope of the present disclosure is not limited to the embodiments described above, and various changes can be made thereto to the extent that the changes do not depart from the intent of the present disclosure.

In addition to the above, the specific description of the shapes, the numbers, the arrangements, the materials, and other factors of the elements of the projector are not limited to those in the embodiments described above and can be changed as appropriate.

The present disclosure will be summarized below as additional remarks.

Additional Remark 1

An optical module including: a light source configured to output light; a light scanner configured to periodically sweep the light output from the light source; and an image light generator configured to generate image light from swept light swept by the light scanner, wherein the light scanner includes a diffractive optical element configured to diffract light at different angles of diffraction in accordance with a light incident position where the light is incident on the diffractive optical element, and a movement mechanism configured to move the diffractive optical element, and the swept light is scanned across the image light generator as the diffractive optical element is moved.

According to the thus configured optical module, in which the diffractive optical element on which the light output from the light source is incident is moved, the image light generator can be scanned with the swept light with the size of the optical module configuration reduced, as compared with the configuration in which a polygonal mirror is used to sweep illumination light as in the related art. The image light generator can therefore generate bright, high-quality image light.

Additional Remark 2

The optical module according to Additional Remark 1, wherein a cross-sectional shape of the swept light that is a shape perpendicular to a chief ray of the swept light is a rectangular shape having lengthwise sides and widthwise sides, and the swept light scans the image light generator in a direction along the widthwise sides.

According to the configuration described above, in which the elongated swept light is swept in the widthwise direction, the image light generator can be efficiently illuminated with the swept light with an increase in the widthwise dimension of the swept light suppressed, as compared with a case where the swept light is swept in the lengthwise direction.

Additional Remark 3

The optical module according to Additional Remark 1 or 2, wherein the movement mechanism is configured to move the diffractive optical element toward one side in an axial direction and another side in the axial direction, the light source is kept turned on while the diffractive optical element is being moved toward the one side in the axial direction and is kept turned off while the diffractive optical element is being moved toward the other side in the axial direction, the image light generator includes a liquid crystal panel having an image formation region where the image light is generated, and a vertical scanning direction in which the image light is generated in the image formation region is the same as a direction in which the swept light scans the image formation region as the diffractive optical element is moved toward the one side in the axial direction.

According to the configuration described above, causing the direction in which the swept light is swept to coincide with the vertical scanning direction of the liquid crystal panel allows the operation of sweeping the swept light to start at a timing before the vertical scanning of the image formation region is completed. Therefore, a situation in which the diffractive optical element is accelerated by the movement mechanism can be suppressed as compared with a case where the operation of sweeping the swept light starts after the vertical scanning is completed, so that a risk of damage or failure of the movement mechanism can be reduced by reducing the load thereon, and the power consumed by the movement mechanism can be suppressed.

Additional Remark 4

The optical module according to Additional Remark 3, wherein a cycle of the vertical scanning of the liquid crystal panel is twice a sweeping cycle of the swept light swept by the light scanner.

According to the configuration described above, moving the diffractive optical element from the one side toward the other side in one frame produced by the liquid crystal panel allows a configuration in which the swept light scans the image formation region.

Additional Remark 5

The optical module according to any one of Additional Remarks 1 to 4, wherein the diffractive optical element is a computer generated hologram.

According to the configuration described above, the angle of diffraction of the light can be controlled with high accuracy by the diffractive optical element configured with a computer generated hologram.

Additional Remark 6

The optical module according to any one of Additional Remarks 1 to 5, wherein the movement mechanism includes a light transmissive disk configured to support the diffractive optical element, and a rotation driver configured to rotate the disk, and the diffractive optical element is disposed along a circumferential direction of the disk.

According to the configuration described above, rotating the disk allows the diffractive optical element to be moved toward one side with respect to the optical axis of the light. The light having passed through the diffractive optical element can therefore scan the image light generator toward the one side.

Additional Remark 7

An optical module including: a light source configured to output light; a light scanner configured to periodically sweep the light output from the light source; and an image light generator configured to generate image light from swept light swept by the light scanner, wherein the light source includes a first light emitter, a second light emitter, and a third light emitter arranged side by side in a sweeping direction in which the swept light is swept, the light scanner includes a first diffractive optical element configured to diffract light incident from the first light emitter to illuminate a first illuminated region of the image light generator, a second diffractive optical element disposed at a position shifted from the first diffractive optical element in the sweeping direction, and configured to diffract light incident from the second light emitter to illuminate a second illuminated region of the image light generator, a third diffractive optical element disposed at a position shifted from the second diffractive optical element in the sweeping direction, and configured to diffract light incident from the third light emitter to illuminate a third illuminated region of the image light generator, and a controller configured to control an operation of driving the first light emitter, the second light emitter, and the third light emitter, and the controller is configured to sequentially turn on the first light emitter, the second light emitter, and the third light emitter so that the first illuminated region, the second illuminated region, and the third illuminated region are sequentially illuminated with the swept light.

According to the thus configured optical module, the light can be sequentially incident on the diffractive optical elements by switching the operation of turning on the light emitters of the light source from one to another. The light output from the diffractive optical elements can thus sequentially scan the illuminated regions of the image light generator. The configuration described above therefore allows the swept light to scan the image light generator while reducing the size of the optical module configuration, as compared with the configuration in which a polygonal mirror is used to sweep illumination light as in the related art. The image light generator can therefore generate bright, high-quality image light.

Additional Remark 8

A projector including: the optical module according to any one of Additional Remarks 1 to 7; and a projection optical apparatus configured to project light output from the optical module.

The thus configured projector can be a projector that projects a high-quality image while suppressing an increase in the size of the projector configuration.

What is claimed is:

1. An optical module comprising:
a light source configured to output light;
a light scanner configured to periodically sweep the light output from the light source; and
an image light generator configured to generate image light from swept light swept by the light scanner,
wherein the light scanner includes
a diffractive optical element configured to diffract light at different angles of diffraction in accordance with a light incident position where the light is incident on the diffractive optical element, and
a movement mechanism configured to move the diffractive optical element, and
the swept light is scanned across the image light generator as the diffractive optical element is moved.

2. The optical module according to claim 1, wherein
a cross-sectional shape of the swept light that is a shape perpendicular to a chief ray of the swept light is a rectangular shape having lengthwise sides and widthwise sides, and
the swept light scans the image light generator in a direction along the widthwise sides.

3. The optical module according to claim 1, wherein
the movement mechanism is configured to move the diffractive optical element toward one side in an axial direction and another side in the axial direction,
the light source is kept turned on while the diffractive optical element is being moved toward the one side in the axial direction and is kept turned off while the diffractive optical element is being moved toward the other side in the axial direction,
the image light generator includes a liquid crystal panel having an image formation region where the image light is generated, and
a vertical scanning direction in which the image light is generated in the image formation region is the same as a direction in which the swept light scans the image formation region as the diffractive optical element is moved toward the one side in the axial direction.

4. The optical module according to claim 3, wherein
a cycle of the vertical scanning of the liquid crystal panel is twice a sweeping cycle of the swept light swept by the light scanner.

5. The optical module according to claim 1, wherein
the diffractive optical element is a computer generated hologram.

6. The optical module according to claim 1, wherein
the movement mechanism includes a light transmissive disk configured to support the diffractive optical element, and a rotation driver configured to rotate the disk, and
the diffractive optical element is disposed along a circumferential direction of the disk.

7. An optical module comprising:
a light source configured to output light;
a light scanner configured to periodically sweep the light output from the light source; and
an image light generator configured to generate image light from swept light swept by the light scanner,
wherein the light source includes a first light emitter, a second light emitter, and a third light emitter arranged side by side in a sweeping direction in which the swept light is swept,
the light scanner includes
a first diffractive optical element configured to diffract light incident from the first light emitter to illuminate a first illuminated region of the image light generator,
a second diffractive optical element disposed at a position shifted from the first diffractive optical element in the sweeping direction, and configured to diffract light incident from the second light emitter to illuminate a second illuminated region of the image light generator,
a third diffractive optical element disposed at a position shifted from the second diffractive optical element in the sweeping direction, and configured to diffract light incident from the third light emitter to illuminate a third illuminated region of the image light generator, and
a controller configured to control an operation of driving the first light emitter, the second light emitter, and the third light emitter, and
the controller is configured to sequentially turn on the first light emitter, the second light emitter, and the third light emitter so that the first illuminated region, the second illuminated region, and the third illuminated region are sequentially illuminated with the swept light.

8. A projector comprising:
the optical module according to claim 1; and
a projection optical apparatus configured to project light output from the optical module.
